(19) United States
(12) Patent Application Publication
(10) Pub. No.: US 2004/0227394 A1
(43) Pub. Date: Nov. 18, 2004

(54) Spoke with tubular coupling end portions

(76) Inventors: Chao-Ying Chen, Tainan Hsien (TW); Truan-Sheng Lui, Taipei (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/602,397

(22) Filed: Jun. 23, 2003

(30) Foreign Application Priority Data
May 12, 2003 (TW) 09 2112817

(51) Int. Cl. B60B 1/00

(52) U.S. Cl. 301/104

(57) ABSTRACT

A spoke is adapted for use in a bicycle wheel that includes a wheel rim and a wheel hub, and includes a spoke body having a pair of coupling end portions that are opposite to each other in a longitudinal direction and that are adapted for connection to the wheel rim and the wheel hub, respectively. At least one of the coupling end portions is tubular. The spoke body further has an intermediate spoke segment that extends in the longitudinal direction and that has opposite ends connected integrally and respectively to the coupling end portions.

### BACKGROUND OF THE INVENTION

1. Field of the Invention

The invention relates to a spoke for a bicycle wheel, more particularly to a spoke having a spoke body formed with tubular coupling end portions that are adapted for connection to a respective one of a wheel rim and a wheel hub of a bicycle wheel.

2. Description of the Related Art

Referring to FIGS. 1 and 2, a conventional bicycle wheel 1 is shown to include a wheel hub 11, a wheel rim 12 disposed around the wheel hub 11, and a plurality of spokes 13 that interconnect the wheel rim 12 and the wheel hub 11. Each spoke 13 has a bent end section 131 hooked on the wheel hub 11 in a respective mounting hole 111 of the latter. Each spoke 13 further has a threaded end section 132 secured to the wheel rim 12 through a respective spoke fastener 14. The spokes 13 can thus interconnect the wheel hub 11 and the wheel rim 12 in a tensioned state.

However, when the bicycle wheel 1 is in use, the load borne by the bicycle wheel 1, such as the weight of the user, can result in slight deformation of the wheel rim 12. This in turn can result in altering of the spokes 13 between tensioned and relaxed states. Bending of the spokes 13 thus occur, which can lead to breaking of the spokes 13 at parts thereof. This phenomenon is more commonly referred to as buckling. Particularly, with reference to FIG. 3, which is a longitudinal cross-sectional view of the conventional spoke 13, breaking of the solid metal spoke body of the conventional spoke 13 can easily occur at the bend (A) of the bent end section 131, and at the junction (B) of smooth and threaded surfaces of the threaded end section 132. There is thus a need to improve the construction of the conventional spoke 13 to make it more resistant to buckling.

### SUMMARY OF THE INVENTION

Therefore, the object of the present invention is to provide a spoke having a spoke body formed with tubular coupling end portions that are adapted for connection to a wheel rim and a wheel hub so as to improve resistance of the spoke to buckling.

According to the present invention, a spoke is adapted for use in a bicycle wheel that includes a wheel rim and a wheel-hub, and comprises a spoke body having a pair of coupling end portions that are opposite to each other in a longitudinal direction and that are adapted for connection to the wheel rim and the wheel hub, respectively. At least one of the coupling end portions is tubular.

In one embodiment, the spoke body further has a tubular intermediate spoke segment that extends in the longitudinal direction and that has opposite ends connected integrally and respectively to the coupling end portions.

In another embodiment, the spoke body further has a solid intermediate segment that extends in the longitudinal direction and that has opposite ends connected integrally and respectively to the coupling end portions.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional bicycle wheel;

FIG. 2 is an exploded perspective view to illustrate a spoke and a wheel hub of the conventional bicycle wheel of FIG. 1;

FIG. 3 is a longitudinal cross-sectional view of the conventional spoke;

FIG. 4 is a partly cross-sectional schematic view of a bicycle wheel that incorporates the first preferred embodiment of a spoke according to the present invention;

FIG. 5 is a longitudinal cross-sectional view of the spoke of the first preferred embodiment;

FIG. 6 is another cross-sectional view of the spoke of the first preferred embodiment, taken along a plane transverse to the longitudinal direction;

FIG. 7 is a longitudinal cross-sectional view of the second preferred embodiment of a spoke according to the present invention;

FIG. 8 is a longitudinal cross-sectional view of the third preferred embodiment of a spoke according to the present invention;

FIG. 9 is a cross-sectional view of the fourth preferred embodiment of a spoke according to the present invention, taken along a plane transverse to a longitudinal direction of the spoke;

FIG. 10 is a cross-sectional view of the fifth preferred embodiment of a spoke according to the present invention, taken along a plane transverse to a longitudinal direction of the spoke;

FIG. 11 is a cross-sectional view of the sixth preferred embodiment of a spoke according to the present invention, taken along a plane transverse to a longitudinal direction of the spoke; and

FIG. 12 is a partly cross-sectional schematic view of a bicycle wheel that incorporates the seventh preferred embodiment of a spoke according to the present invention.

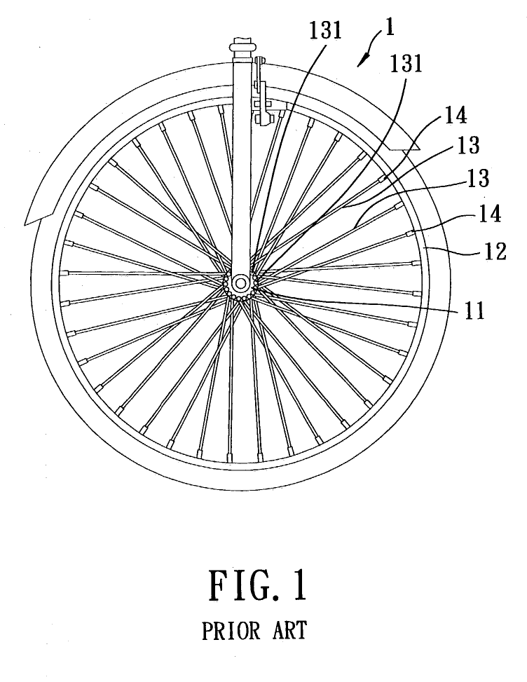

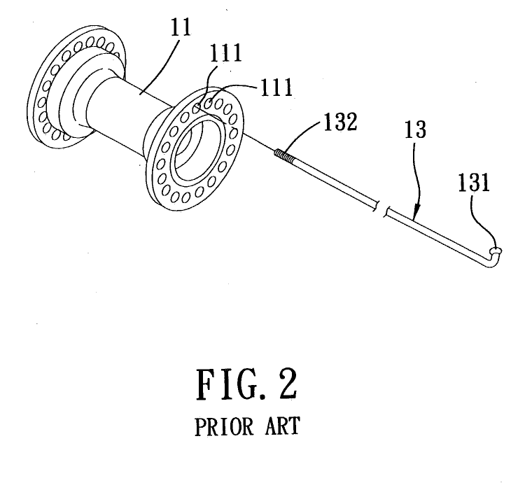

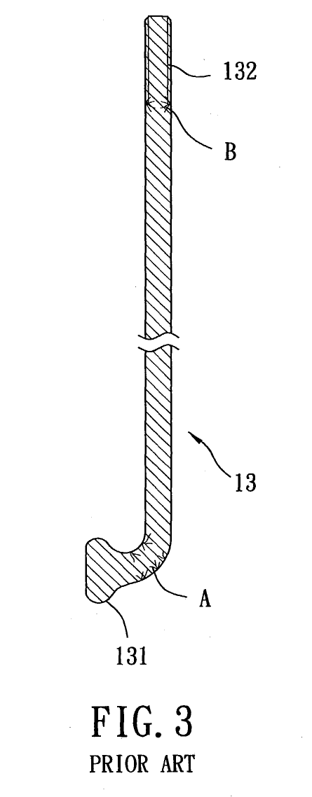

### DETAILED DESCRIPTION OF THE PREFERRED EMBODIMENTS

Before the present invention is described in greater detail, it should be noted that like elements are denoted by the same reference numerals throughout the disclosure.

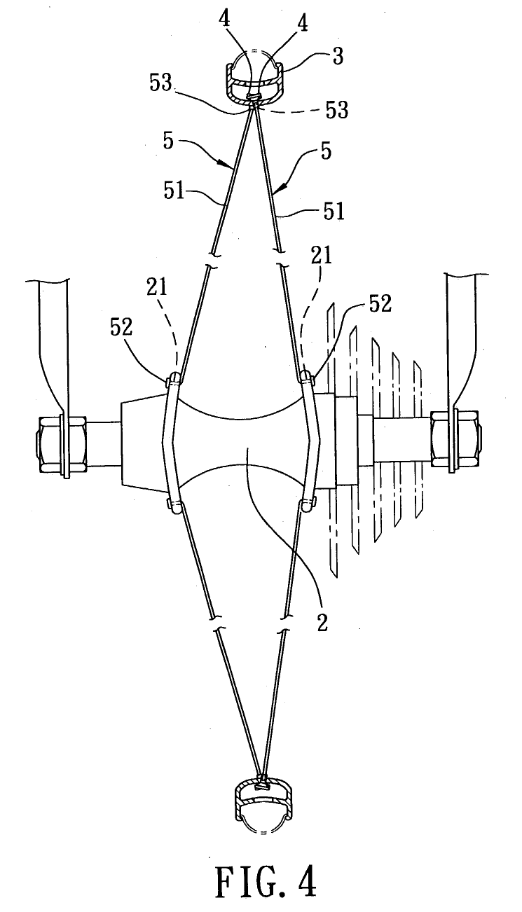

FIG. 4 illustrates a bicycle wheel that incorporates a set of spokes 5 according to the first preferred embodiment of this invention. The bicycle wheel includes a wheel hub 2, and a wheel rim 3 disposed around the wheel hub 2.

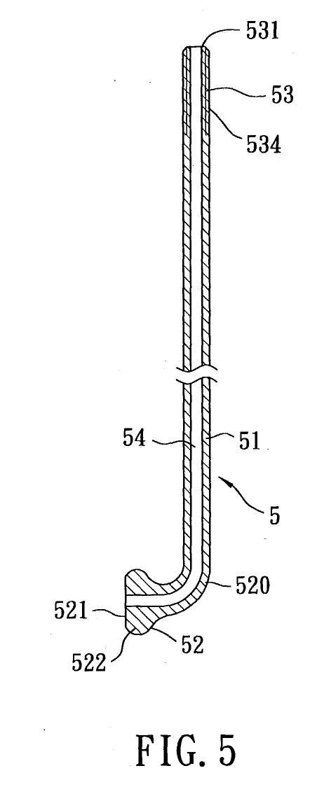

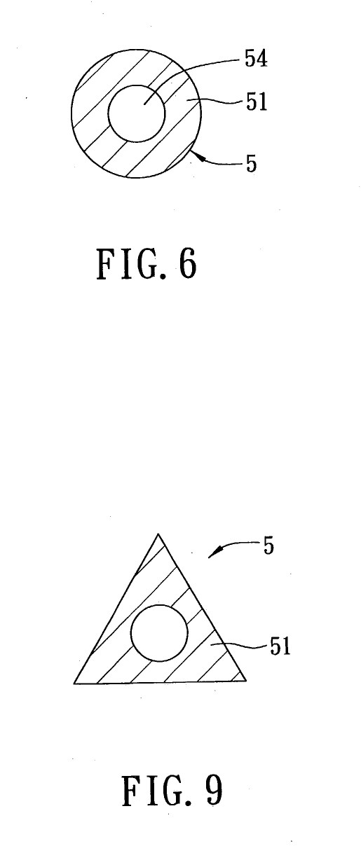

Each of the spokes 5 is disposed to interconnect the wheel hub 2 and the wheel rim 3. With further reference to FIG. 5, each of the spokes 5 includes an integrally formed slender spoke body made of a material, such as metal, and having a pair of tubular coupling end portions 52, 53 that are opposite to each other in a longitudinal direction and that are adapted for connection to the wheel hub 2 and the wheel rim 3, respectively. The spoke body further has a tubular intermediate spoke segment 51 that extends in the longitudinal direction and that has opposite ends connected integrally and respectively to the coupling end portions 52, 53. In this embodiment, the coupling end portion 52 is formed with a bend 520, and has a distal end 521 distal from the other coupling end portion 53 and formed with a radial end flange 522. Accordingly, the coupling end portion 52 can be hooked on the wheel hub 2 in a respective mounting hole 21 of the latter. Moreover, in this embodiment, the coupling end portion 53 is formed with an external screw thread 534, and is secured to the wheel rim 3 through a respective spoke fastener 4 that engages threadedly the external screw thread 534. The coupling end portion 53 further has a distal end 531 distal from the other coupling portion 52. Therefore, in view of the tubular configurations of the integrally connected coupling end portions 52, 53 and the intermediate spoke segment 51, the spoke body of the spoke 5 according to this embodiment is formed with a longitudinal through hole 54 therethrough that extends from one of the distal ends 521, 531 through the other of the distal ends 521, 531. Referring to FIG. 6, the intermediate spoke segment 51 of the spoke body has an outer wall surface with a circular cross-section in a plane transverse to the longitudinal direction and that is uniform throughout the length of the intermediate spoke segment 51.

When the coupling end portions 52, 53 of the spokes 5 interconnect the wheel hub 2 and the wheel rim 3 in a tensioned state, because of the tubular configuration of the coupling end portions 52, 53, the rigidity of the coupling end portions 52, 53 in the longitudinal direction is improved as compared to that of the solid spoke body of the aforementioned conventional spoke, thereby resulting in improved resistance of the spokes 5 to buckling.

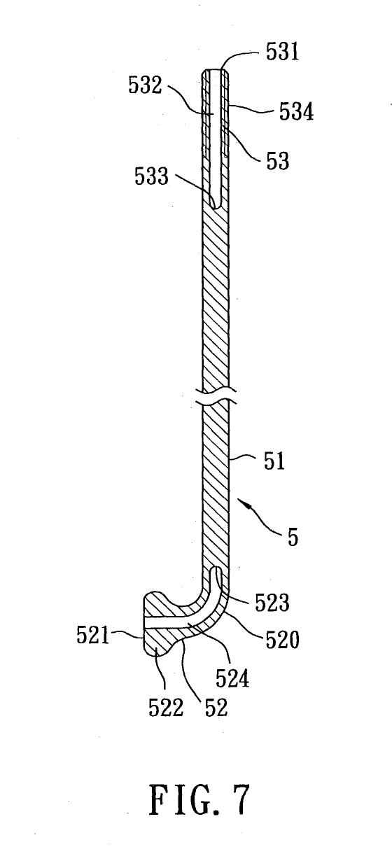

FIG. 7 illustrates the second preferred embodiment of a spoke 5 according to the present invention. As compared to the previous embodiment, the spoke body of the spoke 5 of the present embodiment has a pair of tubular coupling end portions 52, 53 that are opposite to each other in a longitudinal direction and that are adapted for connection to the wheel hub (not shown) and the wheel rim (not shown), respectively, and a solid intermediate spoke segment 51 that extends in the longitudinal direction and that has opposite ends connected integrally and respectively to the coupling end portions 52, 53. The coupling end portion 52 is formed with the bend 520, and has a distal end 521 distal from the other coupling end portion 53 and formed with the radial end flange 522. The coupling end portion 52 confines a blind hole 524 that extends from the distal end 521 and that is configured with a concave bottom 523. The coupling end portion 53 is formed with the external screw thread 534, and has a distal end 531 distal from the other coupling portion 52. The coupling end portion 53 similarly confines a blind hole 532 that extends from the distal end 531 and that is configured with a concave bottom 533.

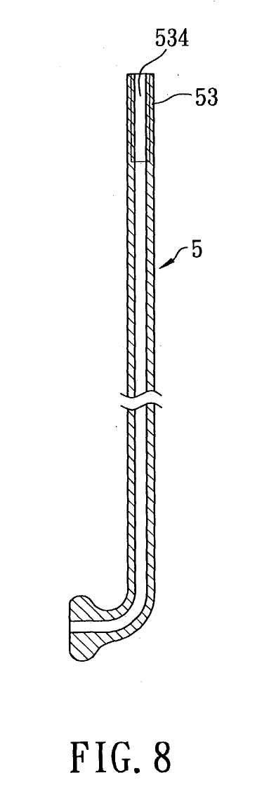

FIG. 8 illustrates the third preferred embodiment of the spoke 5 according to the present invention. As compared to the first preferred embodiment, the tubular coupling end portion 53 of the spoke body of this embodiment is formed with an internal screw thread 534 for threaded engagement with a respective spoke fastener (not shown) on a wheel rim (not shown) of a bicycle wheel.

The cross-section of the intermediate spoke segment 51 of the spoke body of the spoke 5 according to this invention should not be limited to the circular cross-section of the first preferred embodiment. The cross-section of the intermediate spoke segment 51 of the spoke body may be modified, such as to be in the shape of an equilateral polygon, to enhance rigidity of the spoke body in both the longitudinal direction and in directions transverse to the longitudinal direction.

FIG. 9 illustrates the fourth preferred embodiment of a spoke 5 according to the present invention. As compared to the first preferred embodiment, the intermediate spoke segment 51 of the spoke body of this embodiment has an outer wall surface with a cross-section in a plane transverse to a longitudinal direction of the spoke 5, the cross-section being an equilateral triangle in shape.

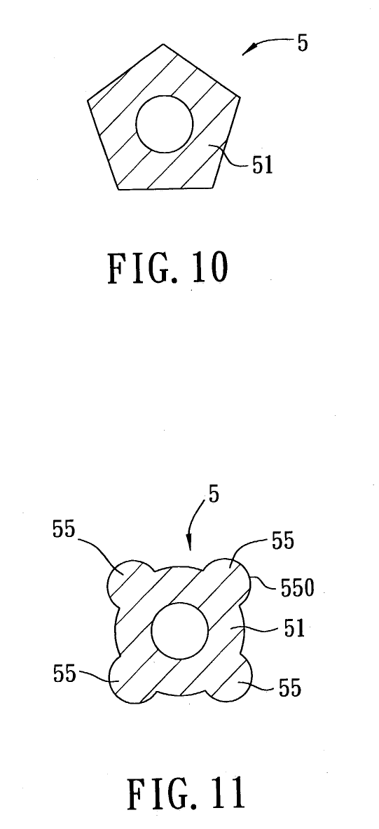

FIG. 10 illustrates the fifth preferred embodiment of a spoke 5 according to the present invention. As compared to the first preferred embodiment, the intermediate spoke segment 51 of the spoke body of this embodiment has an outer wall surface with a cross-section in a plane transverse to a longitudinal direction of the spoke 5, the cross-section being an equilateral pentagon in shape.

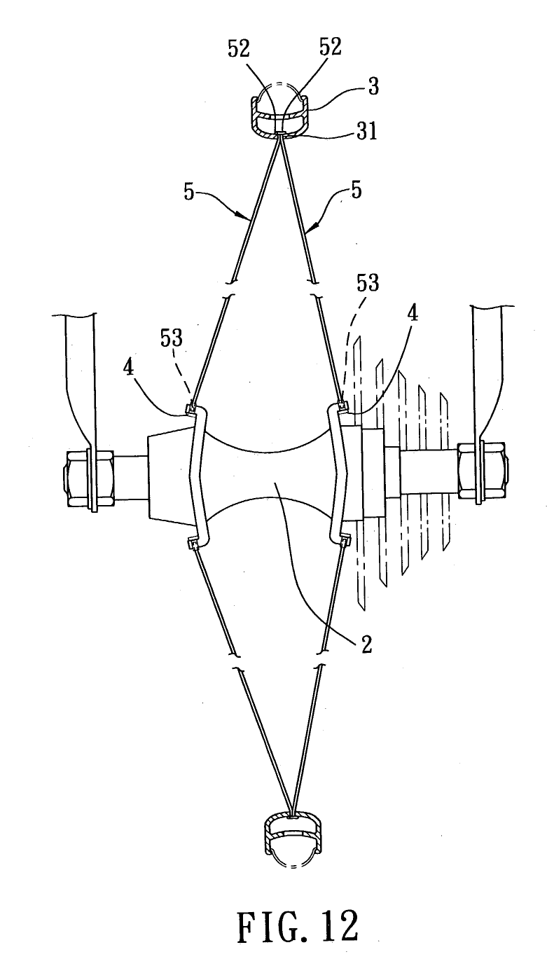

FIG. 11 illustrates the sixth preferred embodiment of a spoke 5 according to the present invention. As compared to the first preferred embodiment, the intermediate spoke segment 51 of the spoke body of this embodiment has an outer wall surface with a circular cross-section in a plane transverse to a longitudinal direction of the spoke 5, and formed with a set of angularly spaced apart protruding ribs 55. In this embodiment, there are four protruding ribs 55, each of which has a convex surface 550 in the plane transverse to the longitudinal direction.

It should be noted herein that the spokes 5 function primarily to reinforce the wheel rim 3 and to position the wheel hub 2 in relation to the center of the wheel rim 3. Hence, the particular connection between each of the tubular coupling end portions 52, 53 of the spoke body of the spoke 5 and the respective one of the wheel hub 2 and the wheel rim 3 should not be limited to those in the first preferred embodiment.

FIG. 12 illustrates a bicycle wheel that incorporates a set of spokes 5 according to the seventh preferred embodiment of this invention. As compared to the bicycle wheel of FIG. 4, the wheel hub 2 is provided with the spoke fasteners 4 for threaded engagement with the tubular coupling end portions 53 of the spokes 5. Moreover, the wheel rim 3 is formed with mounting holes 31 for anchoring of the tubular coupling end portions 52 of the spokes 5 thereat.

In a further embodiment of the spoke according to this invention, each of the tubular coupling end portions of the spoke body is formed with a screw thread for threaded engagement with a corresponding spoke fastener on a respective one of a wheel rim and a wheel hub of a bicycle wheel.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A spoke adapted for use in a bicycle wheel that includes a wheel rim and a wheel hub, said spoke comprising a spoke body having a pair of coupling end portions that are opposite to each other in a longitudinal direction and that are adapted for connection to the wheel rim and the wheel hub, respectively, at least one of said coupling end portions being tubular.

2. The spoke as claimed in claim 1, wherein said spoke body further has a tubular intermediate spoke segment that extends in the longitudinal direction and that has opposite ends connected integrally and respectively to said coupling end portions.

3. The spoke as claimed in claim 1, wherein said spoke body further has a solid intermediate segment that extends in the longitudinal direction and that has opposite ends connected integrally and respectively to said coupling end portions.

4. The spoke as claimed in claim 3, wherein each of said coupling end portions confines a blind hole, said blind hole being configured with a concave bottom.

5. The spoke as claimed in claim 1, wherein one of said coupling end portions is formed with an external screw thread.

6. The spoke as claimed in claim 1, wherein one of said coupling end portions is formed with an internal screw thread.

7. The spoke as claimed in claim 1, wherein one of said coupling end portions is formed with a bend, and has a distal end distal from the other of said coupling end portions and formed a radial end flange.

8. The spoke as claimed in claim 1, wherein said spoke body has an outer wall surface with a circular cross-section in a plane transverse to the longitudinal direction.

9. The spoke as claimed in claim 1, wherein said spoke body has an outer wall surface with a cross-section in a plane transverse to the longitudinal direction, the cross-section being an equilateral polygon in shape.

10. The spoke as claimed in claim 9, wherein the polygon is one of a triangle and a pentagon.

11. The spoke as claimed in claim 1, wherein said spoke body has an outer wall surface with a circular cross-section in a plane transverse to the longitudinal direction, and formed with a set of angularly spaced apart protruding ribs.

12. The spoke as claimed in claim 11, wherein each of said protruding ribs has a convex surface in the plane transverse to the longitudinal direction.
